(19) United States
(12) Patent Application Publication
(10) Pub. No.: US 2017/0059915 A1
(43) Pub. Date: Mar. 2, 2017

(54) DISPLAY DEVICE

(71) Applicant: Japan Display Inc., Minato-ku (JP)

(72) Inventor: Junichi KOBAYASHI, Tokyo (JP)

(73) Assignee: Japan Display Inc., Minato-ku (JP)

(21) Appl. No.: 15/215,975

(22) Filed: Jul. 21, 2016

(30) Foreign Application Priority Data
Aug. 26, 2015 (JP) 2015-166681

(51) Int. Cl. G02F 1/1339; G02F 1/1333; G02F 1/1337; G02F 1/1335; G02F 1/1362; G02F 1/1368

(52) U.S. Cl. CPC G02F 1/13394; G02F 1/136227; G02F 1/1368; G02F 1/133723; G02F 1/133512; G02F 1/133514; G02F 1/133345; G02F 2001/13685; G02F 2001/133738; G02F 2001/13396; G02F 2001/133519; G02F 1/134363

(57) ABSTRACT

According to one embodiment, a display device includes a first substrate, a second substrate opposed to the first substrate, a first spacer disposed on the first substrate and projecting toward the second substrate, and a second spacer disposed on the second substrate, projecting toward the first substrate, and crossing the first spacer, wherein the first spacer includes a first receiving portion and a first projecting portion projecting toward the second substrate with respect to the first receiving portion, and the second spacer includes a second receiving portion contacting the first receiving portion.

### CROSS-REFERENCE TO RELATED APPLICATIONS

This application is based upon and claims the benefit of priority from Japanese Patent Application No. 2015-166681, filed Aug. 26, 2015, the entire contents of which are incorporated herein by reference.

### FIELD

Embodiments described herein relate generally to a display device.

### BACKGROUND

In general, a liquid crystal display device comprises a spacer between a first substrate and a second substrate to maintain a cell gap where a liquid crystal layer is disposed. For example, the spacer extends from a surface of the second substrate toward the first substrate. However, if a display panel is subjected to an external force, there is danger of the spacer damaging an alignment film of the first substrate and causing abnormalities of liquid crystal molecular alignment. As a structure to decrease the possibility of the spacer damaging the alignment film, for example, a liquid crystal display device comprising a first spacer disposed on a first substrate and a second spacer disposed on a second substrate and crossing the first spacer has been disclosed.

### BRIEF DESCRIPTION OF THE DRAWINGS

FIG. 1 is a view showing the structure of a display device of an embodiment.

FIG. 2 is a sectional view of the display panel in the pixel.

FIG. 3 is a plan view of an example of the arrangement of a light-shielding layer and spacers.

FIG. 4 is a sectional view of the display panel along line IV-IV′ of FIG. 3.

FIG. 5 is a sectional view of the display panel along line V-V′ of FIG. 3.

FIG. 6 is a sectional view of a display panel, wherein a first alignment film AL1 and a second alignment film AL2 are interposed between a first spacer SP1 and a second spacer SP2.

FIG. 7 is a plan view showing the positional relationship of contact holes to the spacers.

FIGS. 8A and 8B are views showing a modification of the shapes of the spacers.

FIG. 9 is a view showing a modification of the first spacer.

FIG. 10 is a view showing a modification of the arrangement of the alignment films.

FIG. 11 is a view showing a first modification of the arrangement of the light-shielding layer and the spacers.

FIG. 12 is a view showing a second modification of the arrangement of the light-shielding layer and the spacers.

FIG. 13 is a view showing the arrangement of a light-shielding layer and spacers in a display panel comprising a sub-spacer.

FIG. 14 is a sectional view showing the display panel along line XIV-XIV′ of FIG. 13.

FIG. 15 is a view showing a modification of the first substrate and the first spacer of FIG. 4.

FIG. 16 is a view showing a modification of the second substrate and the second spacer of FIG. 5.

### DETAILED DESCRIPTION

In general, according to one embodiment, a display device comprises: a first substrate; a second substrate opposed to the first substrate; a first spacer disposed on the first substrate and projecting toward the second substrate; and a second spacer disposed on the second substrate, projecting toward the first substrate, and crossing the first spacer, wherein the first spacer comprises a first receiving portion and a first projecting portion projecting toward the second substrate with respect to the first receiving portion, and the second spacer comprises a second receiving portion contacting the first receiving portion.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated in the drawings schematically, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

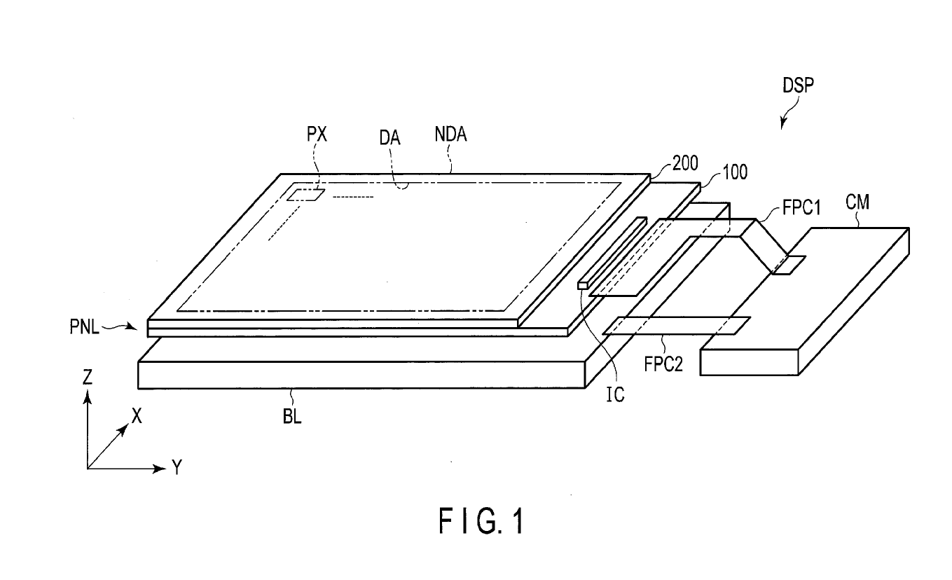

FIG. 1 is a view showing the structure of a display device of an embodiment.

A display device DSP comprises a display panel PNL, a driver integrated circuit chip IC which drives the display panel PNL, an illumination device (backlight unit) BL which illuminates the display panel PNL, a control module CM which controls the operation of the display panel PNL and the illumination device BL, flexible printed circuits FPC1 and FPC2 which transmit control signals to the display panel PNL and the illumination device BL, and the like.

In the present embodiment, a first direction X is assumed to be, for example, a short-side direction of the display panel PNL. A second direction Y is assumed to be a direction which crosses the first direction X and is, in other words, a long-side direction of the display panel PNL. Further, a third direction Z is assumed to be a direction which crosses the first direction X and the second direction Y. Still further, a main surface is assumed to be a plane parallel to the X-Y plane defined by the first direction X and the second direction Y. Still further, the normal line is assumed to be a line perpendicular to the X-Y plane.

The display panel PNL comprises a first substrate 100, a second substrate 200 disposed to be opposed to the first substrate 100, and a liquid crystal layer (liquid crystal layer LQ which will be described later) held between the first substrate 100 and the second substrate 200. The display panel PNL comprises a display area DA serving for image display, and a frame-like non-display area NDA located around the display area DA. Note that, although the display area DA is square in the example shown in the drawing, it may be a different polygonal shape or may be another shape such as circular or elliptical.

The illumination device BL is disposed on the back surface side of the display panel PNL, which is opposed to the first substrate 100. Note that the illumination device BL is not limited to a particular type of illumination device but includes various types of illumination devices, and may be, for example, a direct illumination device, wherein a light-emitting element such as a light-emitting diode (LED) is arranged in a plane parallel to the main surface or an edge-type illumination device, wherein the light-emitting element is arranged at an end of a lightguide plate (not shown). The drive integrated circuit chip IC is mounted on one short side of the first substrate 100. The flexible printed circuit FPC1 is mounted on the driver integrated circuit chip IC side of the first substrate 100, and is connected to the display panel PNL and the control module CM. The flexible printed circuit FPC2 is connected to the illumination device BL and the control module CM.

The display device DSP having the above-described structure corresponds to the so-called transmissive liquid crystal display device having the transmission display function of displaying an image by selectively transmitting light entering the display panel PNL from the illumination device BL on a pixel PX basis. However, the display device DSP may be the so-called reflective liquid crystal display device having the reflective display function of displaying an image by selectively reflecting external light entering the display panel PNL from the outside on a pixel PX basis, or may be a transflective liquid crystal display device having the functions of both the transmissive liquid crystal display device and the reflective liquid crystal display device. In a reflective liquid crystal display device, an illumination device may be omitted or an illumination device (front light unit) may be disposed on the front surface side of the display panel PNL, which is opposed to the second substrate 200. Note that the present embodiment is not limited to a liquid crystal display device and is appropriately applicable to any display device comprising the first substrate 100 and the second substrate 200 opposed to each other with a gap therebetween.

In the following, a transmissive liquid crystal display device will be described as an example of the display device of the present embodiment.

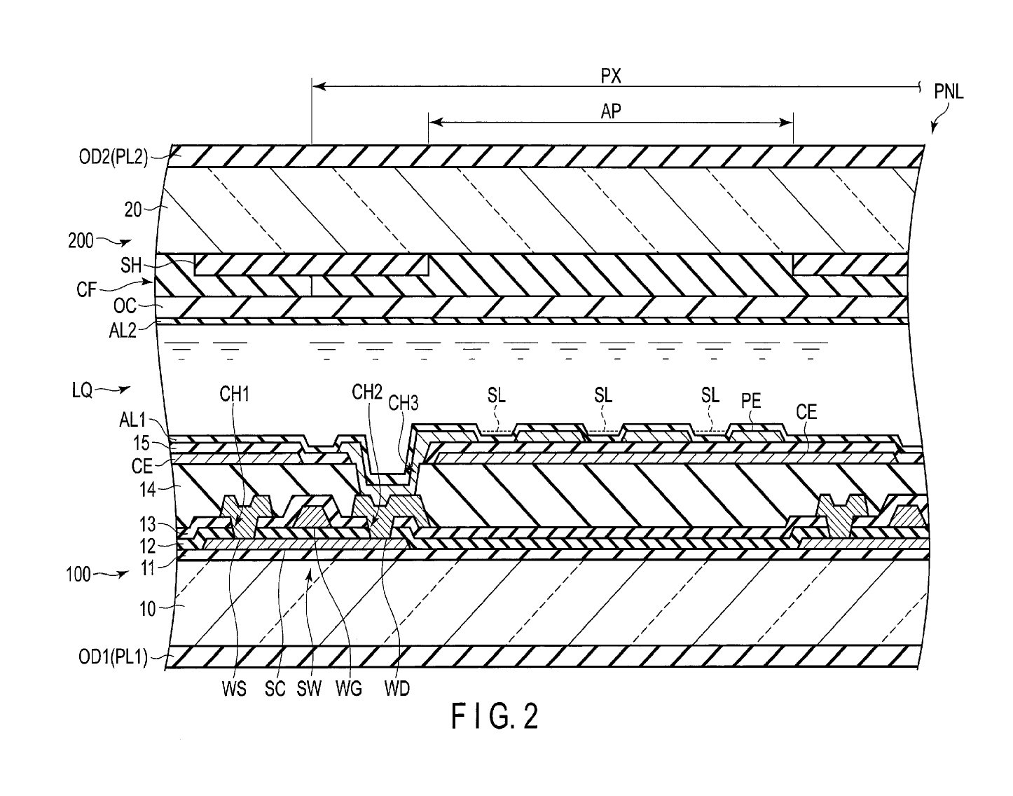

FIG. 2 is a sectional view of the display panel in the pixel.

FIG. 2 is a sectional view of the display panel PNL in the pixel PX disposed in the display area DA. In each layer of the display panel PNL, the upper direction is assumed to be the direction from the first substrate 100 to the second substrate 200 of the display panel PNL, and the lower direction is assumed to be the direction from the second substrate 200 to the first substrate 100 of the display panel PNL.

The first substrate 100 comprises a first insulating substrate 10, a switching element SW, a pixel electrode PE, a common electrode CE, a first insulating film 11, a second insulating film 12, a third insulating film 13, a fourth insulating film 14, a fifth insulating film 15, a first alignment film AL1, and the like. Note that, although the switching element SW is a single-top-gate thin-film transistor in the example shown in the drawing, the switching element SW may be a double-gate thin-film transistor or a bottom-gate thin-film transistor.

The first insulating substrate 10 is formed of a phototransmissive insulating material such as glass or resin. The first insulating film 11 is disposed on the first insulating substrate 10 and covers the first insulating substrate 10. A semiconductor layer SC of the switching element SW is disposed on the first insulating film 11 and is formed in an island shape. The second insulating film 12 is disposed on the first insulating film 11 and the semiconductor layer SC. A gate electrode WG of the switching element SW is disposed on the second insulating film 12 and is opposed to the semiconductor layer SC via the second insulating film 12. The third insulating film 13 is disposed on the second insulating film 12 and the gate electrode WG. A source electrode WS and a drain electrode WD of the switching element SW are disposed on the third insulating film 13 and are electrically connected to the semiconductor layer SC respectively via a contact hole CH1 and a contact hole CH2. The fourth insulating film 14 is disposed on the third insulating film 13, the source electrode WS and the drain electrode WD.

The common electrode CE is disposed on the fourth insulating film 14. The fifth insulating film 15 is formed on the fourth insulating film 14 and the common electrode CE. The first insulating film 11, the second insulating film 12, the third insulating film 13 and the fifth insulating film 15 are formed of an inorganic insulating material such as a silicon nitride (SiN) or a silicon oxide (SiO). The fourth insulating film 14 is formed of, for example, an organic insulating material. The pixel electrode PE is disposed on the fifth insulating film 15 and is electrically connected to the drain electrode WD of the contact hole CH3. The pixel electrode PE is opposed to the common electrode CE in an area corresponding to an aperture AP, which will be described later. In the aperture AP, the pixel electrode PE comprises at least one slit SL. The common electrode CE and the pixel electrode PE are formed of, for example, a transparent conductive material such as indium-tin-oxide (ITO) or indium-zinc-oxide (IZO). The first alignment film AL1 is disposed on the fifth insulating film 15 and the pixel electrode PE.

Note that, although the pixel electrode PE is located at the liquid crystal layer LQ side with respect to the common electrode CE in the example shown in the drawing, the common electrode CE may be located at the liquid crystal layer LQ side with respect to the pixel electrode PE. In that case, the slit SL will be formed in the common electrode CE. Alternatively, the pixel electrode PE and the common electrode CE may be formed in a comb-like shape and disposed on the same layer.

The second substrate 200 comprises a second insulating substrate 20, a light-shielding layer SH, a color filter CF, an overcoat layer OC, and a second alignment film AL2.

The second insulating substrate 20 is formed of a phototransmissive insulating material such as glass or resin. The light-shielding layer SH is disposed on the lower surface side of the second insulating substrate 20. The pixel PX comprises the aperture AP in an area surrounded by the light-shielding layer SH. The color filter CF is disposed on the lower surface side of the second insulating substrate 20 and the light-shielding layer SH. The edges of the color filter CF overlap the light-shielding layer SH. Note that, although the color filter CF is assumed to include, for example, a red filter, a green filter and a blue filter, the color filter CF is not necessarily limited to these colors and may include another color such as white (colorless). Further, the color filter CF may be formed on the first substrate 100. The overcoat layer OC is disposed on the lower surface side of the color filters CF and covers the color filters CF.

The second alignment film AL2 is disposed on the lower surface side of the overcoat layer OC. The first alignment film AL1 and the second alignment film AL2 are formed of, for example, an organic material having horizontal alignment properties such as polyimide, and are subjected to alignment treatment such as a rubbing treatment or photoalignment treatment.

The liquid crystal layer LQ is held in the gap between the first substrate 100 and the second substrate 200. In a state where no electric field is produced between the pixel electrode PE and the common electrode CE, the liquid crystal molecules included in the liquid crystal layer LQ receive an alignment restriction force from the first alignment film AL1 and the second alignment film AL2 and are thus initially aligned in a direction parallel to the main surfaces of the first substrate 100 and the second substrate 200.

A first optical element OD1 is disposed on the back surface side of the display panel PNL, and a second optical element OD2 is disposed on the front surface side of the display panel PNL. The first optical element OD1 comprises a first polarizer PL1, and the second optical element OD2 comprises a second polarizer PL2. The first polarizer PL1 and the second polarizer PL2 are arranged, for example, such that their absorption axes are orthogonal to each other. Note that the first optical element OD1 and the second optical element OD2 may further comprise other function layers such as a retardation film and a surface treatment layer.

In the example shown in the drawing, the display panel PNL has a structure where the first substrate 100 comprises both the pixel electrode PE and the common electrode CE, that is, a structure corresponding to a display mode mainly using a lateral electric field parallel to the substrate main surface. However, the display panel PNL is not necessarily limited to a particular display mode but may have a structure corresponding to a display mode using a longitudinal electric field perpendicular to the substrate main surface, a display mode using an oblique electric field inclined to the substrate main surface, or a display mode using a combination thereof. In the display mode using the longitudinal electric field or the oblique electric field, for example, a structure where the first substrate 100 comprises the pixel electrode PE and the second substrate 200 comprises the common electrode CE is applicable.

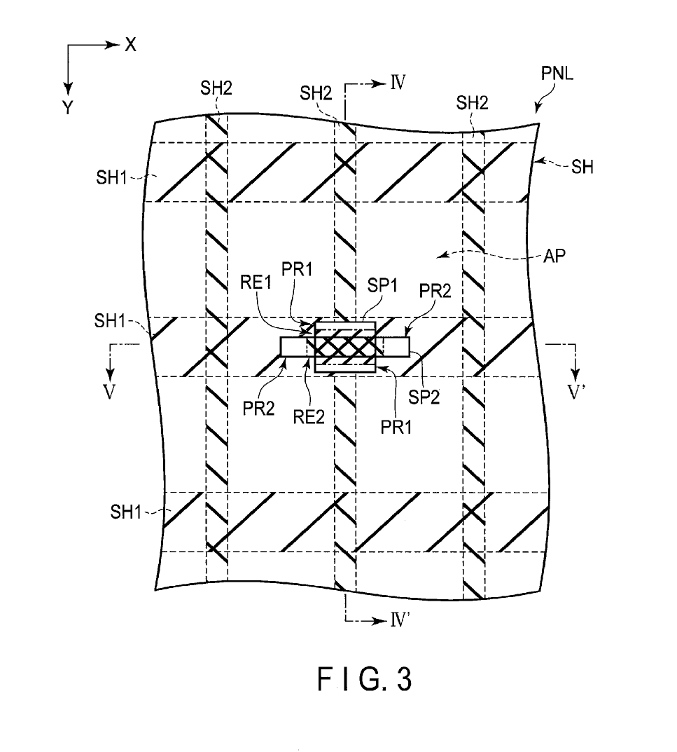

FIG. 3 is a plan view of an example of the arrangement of a light-shielding layer and spacers.

The display panel PNL further comprises a first spacer SP1 and a second spacer SP2 in a position opposed to the light-shielding layer SH.

The light-shielding layer SH comprises a first extension portion SH1 and a second extension portion SH2 crossing the first extension portion SH1. In the example shown in the drawing, the first extension portion SH1 extends in the first direction X, and the second extension portion SH2 extends in the second direction Y. The aperture AP is an area surrounded by the first extension portions SH1 and the second extension portions SH2, and in the example shown in the drawing, the rectangular apertures AP are arranged in a matrix. The first extension portions SH1 are arranged in the second direction Y separately from each other. The second extension portions SH2 are arranged in the first direction X separately from each other. For example, all the first extension portions SH1 have the same width as each other, and all the second extension portions SH2 have the same width as each other. Note that, although the first extension portion SH1 and the second extension portion SH2 are formed linearly in the example shown in the drawing, the first extension portion SH1 and the second extension portion SH2 are not necessarily formed in this manner but may be formed at least partly windingly. Since the switching element SW and the third contact hole CH3 of FIG. 2 are disposed to be opposed to the first extension portion SH1, the width of the first extension portion SH1 in the second direction Y should preferably be greater than the width of the second extension portion SH2 in the first direction X.

The first spacer SP1 and the second spacer SP2 cross each other. The first spacer SP1 and the second spacer SP2 are disposed in a position where the first extension portion SH1 and the second extension portion SH2 cross each other. For example, the first spacer SP1 and the second spacer SP2 are entirely opposed to the first extension portion SH1 and are partly opposed to the second extension portion SH2. Further, the first spacer SP1 and the second spacer SP2 are located away from the aperture AP.

The first spacer SP1 comprises a first receiving portion RE1 and a first projecting portion PR1. The first receiving portion RE1 corresponds to a portion shaded with diagonal lines rising from bottom left to top right in the drawing. The first projecting portion PR1 is located outside of the first receiving portion RE1 in the second direction Y. The first receiving portion RE1 and the first projecting portion PR1 are arranged in the second direction Y. The first receiving portion RE1 and the first projecting portion PR1 are continuously formed. Note that, although the first projecting portion PR1 is disposed at each end of the first receiving portion RE1 in the example shown in the drawing, the first projecting portion PR1 may be disposed at one end of the first receiving portion RE1 at least.

The second spacer SP2 comprises a second receiving portion RE2 and a second projecting portion PR2. The second receiving portion RE2 corresponds to a portion shaded with diagonal lines extending from top left to bottom right in the drawing. The second receiving portion RE2 is partly opposed to the first receiving portion RE1. The second projecting portion PR2 is located outside of the second receiving portion RE2 in the first direction X. The second receiving portion RE2 and the second projecting portion PR2 are arranged in the first direction X. The second receiving portion RE2 and the second projecting portion PR2 are continuously formed. Note that, although the second projecting portion PR2 is disposed at each end of the second receiving portion RE2 in the example shown in the drawing, the second projecting portion PR2 may be disposed at one end of the second receiving portion RE2 at least.

The sectional structures of the first spacer SP1 and the second spacer SP2 will be described below. It should be noted that only structures necessary for explanation are illustrated in the drawing.

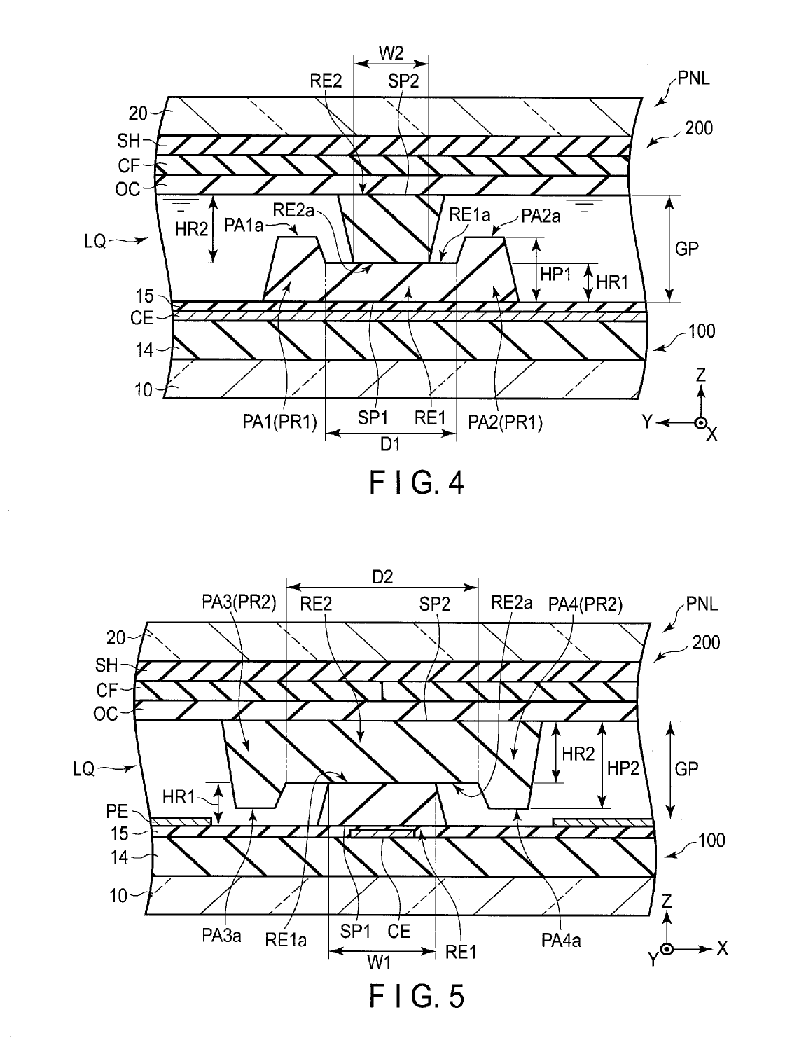

FIG. 4 is a sectional view of the display panel along line IV-IV′ of FIG. 3.

Between the first substrate 100 and the second substrate 200, a cell gap GP is supported by the first spacer SP1 and the second spacer SP2. The cell gap GP corresponds to a distance in the third direction Z (along the normal line) between the upper surface of the first substrate 100 at the second substrate 200 side and the lower surface of the second substrate 200 at the first substrate 100 side. In other words, the cell gap GP corresponds to a thickness of the liquid crystal layer LQ in the third direction Z.

The first spacer SP1 is disposed on the first substrate 100. For example, the first spacer SP1 is formed on the fifth insulating film 15 by means of a photoresist. The first spacer SP1 projects toward the second substrate 200. The first projecting portion PR1 projects toward the second substrate 200 with respect to the first receiving portion RE1. However, the first projecting portion PR1 is separated from the second substrate 200. In the example shown in the drawing, the first projecting portion PR1 comprises a first portion PA1 and a second portion PA2 disposed respectively at both ends of the first receiving portion RE1. The first receiving portion RE1 is arranged between the first portion PA1 and the second portion PA2 in the second direction Y.

The second spacer SP2 is disposed on the second substrate 200. For example, the second spacer SP2 is formed below the overcoat layer OC by means of a photoresist. Note that the second spacer SP2 and the overcoat layer OC may be formed of the same material as each other and may be formed integrally with each other. The second spacer SP2 projects toward the first substrate 100. The first receiving portion RE1 and the second receiving portion RE2 are supported on each other in the third direction Z. Note that, although the first receiving portion RE1 and the second receiving portion RE2 are directly in contact with each other in the example shown in the drawing, the first receiving portion RE1 and the second receiving portion RE2 may be indirectly in contact with each other via other members (such as the first alignment film and the second alignment film).

The first receiving portion RE1 has a top surface RE1a on the upper side. The first portion PA1 has a first top surface PA1a on the upper side. As in the case of the first portion PA1, the second portion PA2 has a second top surface PA2a. The second receiving portion RE2 has a top surface RE2a on the lower side. In the example shown in the drawing, the top surface RE1a is in contact with the top surface RE2a. The first top surface PA1a and the second top surface PA2a are opposed to the second substrate 200 via the liquid crystal layer LQ in the third direction Z.

The first receiving portion RE1 has a height HR1. The first projecting portion PR1 has a height HP1. The second receiving portion RE2 has a height HR2. Note that the height HR1 corresponds to a height from the bottom surface on the lower side of the first spacer SP1 (the interface with the fifth insulating film 15) to the top surface RE1a in the third direction Z. Further, the height HP1 corresponds to a height from the bottom surface of the first spacer SP1 to the first top surface PA1a and the second top surface PA2a in the third direction Z. Still further, the height HR2 corresponds to a height from the bottom surface on the upper side of the second spacer SP2 (the interface with the overcoat layer OC) to the top surface RE2a in the third direction Z. Note that, although the height of the first portion PA1 and the height of the second portion PA2 equally correspond to the height HP1 in the example shown in the drawing, the height of the first portion PA1 and the height of the second portion PA2 are not necessarily the same as each other but may be different from each other. The cell gap GP is greater than the height HP1 of the first projecting portion PR1. The cell gap GP is less than the sum of the height HP1 of the first projecting portion PR1 and the height HR2 of the second receiving portion RE2.

The second receiving portion RE2 has a width W2 in the second direction Y. The first receiving portion RE1 has a length D1 in the second direction Y. In the example shown in the drawing, the length D1 corresponds to the gap between the first portion PA1 and the second portion PA2 in the second direction Y. The length D1 of the first receiving portion RE1 is greater than or equal to the width W2 of the second receiving portion RE2.

FIG. 5 is a sectional view of the display panel along line V-V′ of FIG. 3. For example, the first receiving portion RE1 is opposed to the boundary of the color filters CF in the third direction Z. Further, the first receiving portion RE1 is arranged between the pixel electrodes PE in the first direction X. Note that, in the example shown in the drawing, a part of the common electrode CE is located directly below the first receiving portion RE1. The second spacer SP2 is also arranged between the pixel electrodes PE. The second projecting portion PR2 of the second spacer SP2 projects toward the first substrate 100 with respect to the second receiving portion RE2. However, the second projecting portion PR2 is separated from the first substrate 100. In the example shown in the drawing, the second projecting portion PR2 comprises a third portion PA3 and a fourth portion PA4 disposed respectively at both ends of the second receiving portion RE2. The second receiving portion RE2 is arranged between the third portion PA3 and the fourth portion PA4 in the first direction X.

The first receiving portion RE1 and the first projecting portion PR1 are formed of the same material as each other. Further, the second receiving portion RE2 and the second projecting portion PR2 are formed of the same material as each other. However, the first receiving portion RE1 and the first projecting portion PR1 may be formed of different materials from each other, and the second receiving portion RE2 and the second projecting portion PR2 may be formed of different materials from each other. In a case where the first receiving portion RE1 and the first projecting portion PR1 are formed of the same material as each other, it is possible to form the first receiving portion RE1 and the first projecting portion PR1 simultaneously by using a gradated mask such as a grayscale mask or a half-tone mask.

The third portion PA3 has a third top surface PA3a on the lower side. As in the case of the third portion PA3, the fourth portion PA4 has a fourth top surface PA4a. The third top surface PA3a and the fourth top surface PA4a are opposed to the first substrate 100 via the liquid crystal layer LQ in the third direction Z.

The second projecting portion PR2 has a height HP2. Note that the height HP2 corresponds to a height from the bottom surface of the second spacer SP2 to the third top surface PA3a and the fourth top surface PA4a in the third direction Z. Further, although the height of the third portion PA3 and the height of the fourth portion PA4 equally correspond to the height HP2 in the example shown in the drawing, the height of the third portion PA3 and the height of the fourth portion PA4 are not necessarily the same as each other but may be different from each other. The cell gap GP is greater than the height HP2 of the second projecting portion PR2. The cell gap GP is less than the sum of the height HP2 of the second projecting portion PR2 and the height HP1 of the first receiving portion RE1. Further, the cell gap GP is substantially the same as the sum of the height HR1 and the height HR2.

However, there is a case where the cell gap GP is formed in a state where the first spacer SP1 and the second spacer SP2 are elastically deformed. In that case, if the first substrate 100 and the second substrate 200 are separated from each other, the first spacer SP1 and the second spacer SP2 are restored, and consequently the heights HR1 and HR2 will be greater than those before the first substrate 100 and the second substrate 200 are separated from each other. Further, there is also a case where the height HR1 of one portion of the first receiving portion RE1 which supports the second receiving portion RE2 is less than that of the other portion, and the height HR2 of one portion of the second receiving portion RE2 which supports the first receiving portion RE1 is less than that of the other portion. Therefore, in the present embodiment, the cell gap GP is defined as less than or equal to the sum of the height HR1 of the first receiving portion RE1 and the height HR2 of the second receiving portion RE2.

The first receiving portion RE1 has a width W1 in the first direction X. The second receiving portion RE2 has a length D2 in the first direction X. In the example shown in the drawing, the length D2 corresponds to the gap between the third portion PA3 and the fourth portion PA4 in the first direction X. The length D2 of the second receiving portion RE2 is greater than or equal to the width W1 of the first receiving portion RE1.

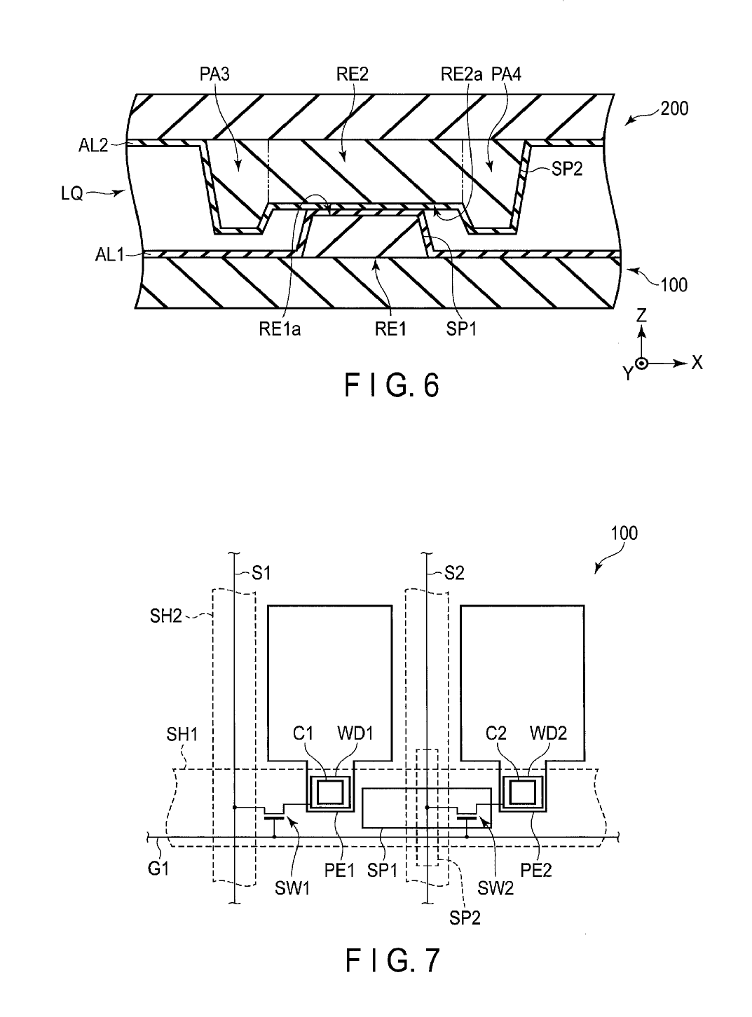

FIG. 6 is a sectional view of a display panel where the first alignment film AL1 and the second alignment film AL2 are interposed between the first spacer SP1 and the second spacer SP2.

In an area corresponding to the display area DA, the first alignment film AL1 is continuously formed across the surface of the first substrate 100 at the second substrate 200 side. Therefore, the first alignment film AL1 covers the first spacer SP1. Further, in an area corresponding to the display area DA, the second alignment film AL2 is continuously formed across the surface of the second substrate 200 at the first substrate 100 side. Therefore, the second alignment film AL2 covers the second spacer SP2. That is, the first alignment film AL1 and the second alignment film AL2 are disposed between the top surface RE1a and the top surface RE2a.

As described above, the display device DSP of the present embodiment comprises the first spacer SP1 formed on the first substrate 100, and the second spacer SP2 formed on the second substrate 200 and crossing the first spacer SP1. The first spacer SP1 comprises the first receiving portion RE1, and the first projecting portion PR1 located outside of the first receiving portion RE1, and the second spacer SP2 comprises the second receiving portion RE2 which supports the first receiving portion RE1. Therefore, even if the display panel PNL is subjected to an external force, the second spacer SP2 contacts the first projecting portion PR1, and thus substrate misalignment occurring as the second spacer SP2 moves toward the first projecting portion PR1 can be prevented. Consequently, according to the present embodiment, a display device DSP which can prevent substrate misalignment can be achieved.

Since the first projecting portion PR1 comprises the first portion PA1 and the second portion PA2 respectively at both ends of the first receiving portion RE1, substrate misalignment occurring as the second spacer SP2 moves toward the first portion PA1 as well as substrate misalignment occurring as the second spacer SP2 moves toward the second portion PA2 can be prevented.

The cell gap GP is greater than the height HP1, and the first projecting portion PR1 is separated from the second substrate 200. Therefore, even when the substrates are misaligned, the first top surface PA1a and the second top surface PA2a will not contact the surface of the second substrate 200 at the first substrate 100 side. Consequently, the second alignment film AL2 of the second substrate 200 will not be damaged by the first projecting portion PR1, and thus disturbances of the liquid crystal molecule alignment caused by the damage to the second alignment film AL2 can be prevented. As a result, in the periphery of the first spacer SP1, display errors such as passing-through of light caused by the disturbances of the liquid crystal molecule alignment can be suppressed, and this can prevent a decrease in contrast ratio. In this way, the display device DSP can prevent a decrease in display quality.

Further, the cell gap GP is less than the sum of the height HP1 and the height HR2. The same also applies to a case where an external force is further applied to the display panel PNL to the extent that the display panel PNL sags down. Therefore, even if the display panel PNL is subjected to a large external force, the second receiving portion RE2 will not move beyond the first portion PA1 or the second portion PA2. Consequently, even if the display device DSP is subjected to a large external force, the substrate misalignment can be prevented, and the cell gap can be maintained by the first spacer SP1 and the second spacer SP2.

The length D1 is greater than or equal to the width W2. In a case where the length D1 is the same as the width W2, the first spacer SP1 and the second spacer SP2 tightly engage with each other, and thus the substrate misalignment can be more reliably prevented. Further, in a case where the length D1 is greater than the width W2, even if there are variations in accuracy of forming the first spacer SP1 and the second spacer SP2 or variations in accuracy of attaching the first substrate 100 and the second substrate 200 to each other, a uniform cell gap can still be formed by the first receiving portion RE1 and the second receiving portion RE2.

Note that, as in the case of the first spacer SP1, the second spacer SP2 comprises the second projecting portion RE2 outside of the second receiving portion RE2, and thus a display device DSP which can prevent substrate misalignment occurring as the first spacer SP1 moves toward the second projecting portion PR2 can be achieved. Further, since the second projecting portion PR2 comprises the third portion PA3 and the fourth portion PA4 disposed respectively at both ends of the second receiving portion RE2, substrate misalignment occurring as the first spacer SP1 moves toward the third portion PA3 as well as substrate misalignment occurring as the first spacer SP1 moves toward the fourth portion PA4 can be prevented.

Since the cell gap GP is greater than the height HP2 and the second projecting portion PR2 is separated from the first substrate 100, the first alignment film AL1 of the first substrate 100 will not be damaged by the second projecting portion PR2, and thus disturbances of the liquid crystal molecule alignment caused by the damage to the first alignment film AL1 can be prevented.

Further, the cell gap GP is less than the sum of the height HP2 and the height HR1. Therefore, the first receiving portion RE1 will not move beyond the third portion PA3 or the fourth portion PA4. Consequently, even if the display device DSP is subjected to a large external force, the display device DSP can prevent substrate misalignment.

The length D2 is greater than or equal to the width W1. In a case where the length D2 is equal to the width W1, substrate misalignment can be more reliably prevented. Further, in a case where the length D2 is greater than the width W1, a uniform cell gap can still be formed by the first receiving portion RE1 and the second receiving portion RE2.

The first spacer SP1 and the second spacer SP2 are disposed in a position where the first extension portion SH1 and the second extension portion SH2 cross each other. In this structure, it is possible to increase the size of the first receiving portion RE1 and the size of the second receiving portion RE2, and thus even if a greater load is imposed on the first spacer SP1 and the second spacer SP2, it is still possible to support the cell gap GP. Consequently, the display device DSP can reduce the number of the first spacers SP1 and the second spacers SP2.

The first spacer SP1 is covered with the first alignment film AL1, and the second spacer SP2 is covered with the second alignment film AL2. At this time, since the first alignment film AL1 is simply formed on the entire surface of the first substrate 100, the first alignment film AL1 can be easily formed. As in the case of the first alignment film AL1, the second alignment film AL2 can also be easily formed.

Next, a modification of the present embodiment will be described. Note that the following modification can produce the same technical effect as that produced by the above-described embodiment.

FIG. 7 is a plan view showing the positional relationship of contact holes to the spacers.

In the present modification, the first substrate 100 comprises a scan line G, a first signal line S1, a second signal line S2, a first switching element SW1, a second switching element SW2, a first drain electrode WD1, a second drain electrode WD2, a first pixel electrode PE1 and a second pixel electrode PE2.

The first extension portion SH1 is wider than the second extension portion SH2. The scan line G is opposed to the first extension portion SH1. The first signal line S1 and the second signal line S2 are opposed respectively to their adjacent second extension portions SH2. The first switching element SW1 and the second switching element SW2 are opposed to the first extension portion SH1. The first switching element SW1 is electrically connected to the scan line G and the first signal line S1. The second switching element SW2 is electrically connected to the scan line G and the second signal line S2. The first drain electrode WD1 and the second drain electrode WD2 are opposed to the first extension portion SH1. The first drain electrode WD1 is electrically connected to the first switching element SW1. The first pixel electrode PE1 is electrically connected to the first drain electrode WD1 via a first contact hole C1. The second drain electrode WD2 is electrically connected to the second switching element SW2. The second pixel electrode PE2 is electrically connected to the second drain electrode WD2 via a second contact hole C2. The first pixel electrode PE1 and the second pixel electrode PE2 are disposed in an area surrounded by the light-shielding layer SH.

The first spacer SP1 is arranged along the first extension portion SH1. The second spacer SP2 is arranged along the second extension portion SH2. The second spacer SP2 is disposed on the second substrate 200 where the light-shielding layer SH is disposed. In this way, when the second spacer SP2 extending along the second extension portion SH2, which is narrower than the first extension portion SH1, is disposed on a substrate where the light-shielding layer SH1 is disposed, a margin for misalignment of the first substrate 100 and the second substrate 200 in the attachment process can be increased.

The first spacer SP1 is disposed on the first substrate 100 where the first drain electrode WD1 and the second drain electrode WD2 are disposed. The first spacer SP1 is located between the first contact hole C1 and the second contact hole C2 adjacent to each other. Therefore, even if the display device DSP develops into a higher-definition display device and has a narrower pitch between the contact holes, misalignment of the first substrate 100 and the second substrate 200 in the attachment process as well as misalignment of the first substrate 100 and the second substrate 200 on being pressed against each other can be prevented, and thus the first spacer SP1 and the second spacer SP2 will not be pushed into the contact holes. Consequently, a desired cell gap can be maintained by the first spacer SP1 and the second spacer SP2.

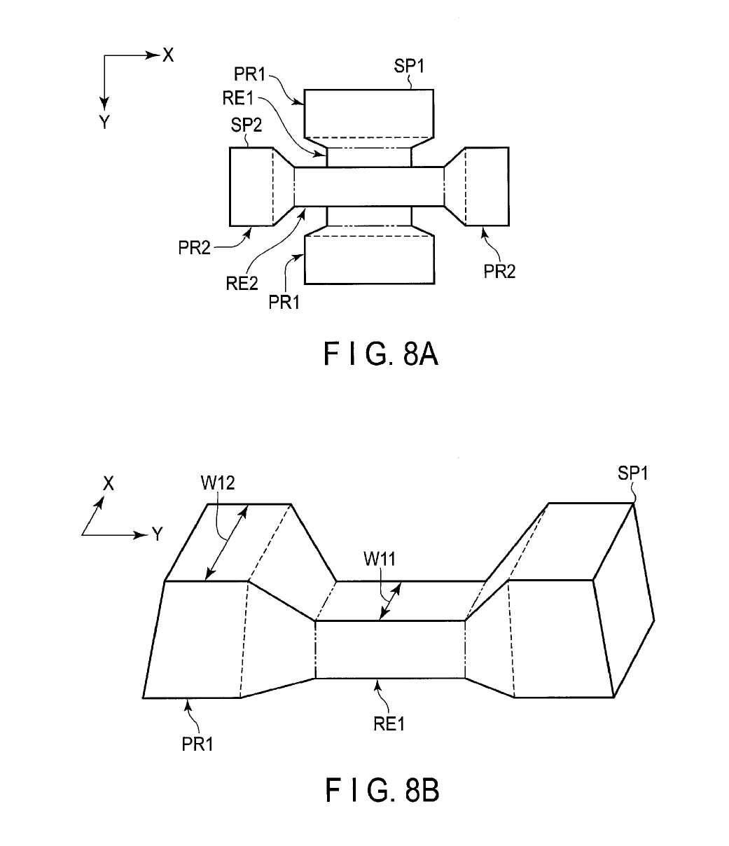

FIGS. 8A and 85 are views showing a modification of the shapes of the spacers. FIG. 8A is a plan view of the first spacer SP1 and the second spacer SP2 as viewed from the third direction Z. FIG. 8B is a perspective view of the first spacer SP1.

In the present modification, the first spacer SP1 is constricted in the first receiving portion RE1. Similarly, the second spacer SP2 is constricted in the second receiving portion RE2. That is, as shown in plan view FIG. 8B, between the first receiving portion RE1 and the first projecting portion PR1 arranged in the second direction Y, the width W11 of the first receiving portion RE1 in the first direction X is less than the width W12 of the first projecting portion PR1 in the first direction X. Between the second receiving portion RE2 and the second projecting portion PR2 arranged in the first direction X, although not shown in the drawing, the width of the second receiving portion RE2 in the second direction Y is less than the width of the second projecting portion PR2 in the second direction Y. Note that only the first spacer SP1 may be constricted or only the second spacer SP2 may be constricted.

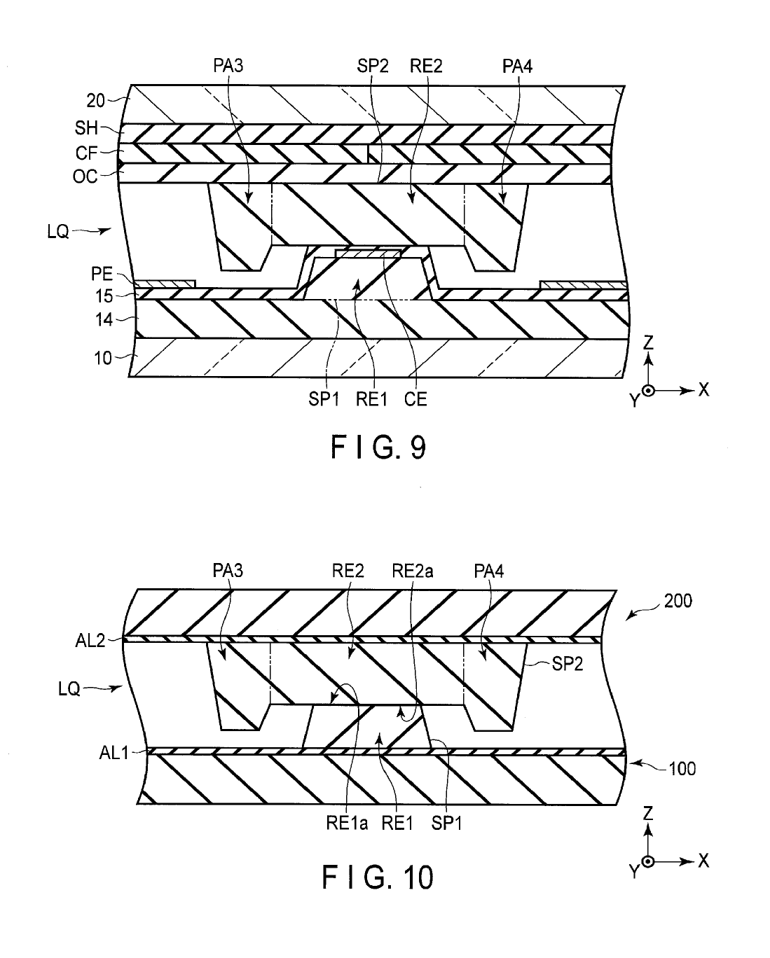

FIG. 9 is a view showing a modification of the first spacer.

The present modification is different from the structural example of FIG. 5 in that the first spacer SP1 is disposed on the fourth insulating film 14.

The common electrode CE is disposed on the top surface RE1a. The fifth insulating film 15 covers the fourth insulating film 14, the first spacer SP1 and the common electrode CE. The second receiving portion RE2 supports the first receiving portion RE1 via the common electrode CE and the fifth insulating film 15. The first spacer SP1 can be formed of the same material as that of the fourth insulating film 14. Further, it is possible to simplify the manufacturing process of the first substrate 100 by forming the first spacer SP1 simultaneously with the fourth insulating film 14. Therefore, the display device DSP can decrease the manufacturing cost.

FIG. 10 is a view showing a modification of the arrangement of the alignment films.

The present modification is different from the structural example of FIG. 6 in that the first alignment film AL1 is disposed below the first spacer SP1 and the second alignment film AL2 is disposed above the second spacer SP2.

In the present modification, when the substrates are misaligned, the first alignment film AL1 and the second alignment film AL2 between the top surface RE1a and the top surface RE2a will not be damaged, and thus broken pieces of the alignment films will not be mixed into the liquid crystal layer LQ. Therefore, a display device DSP which can prevent a decrease in display quality can be achieved.

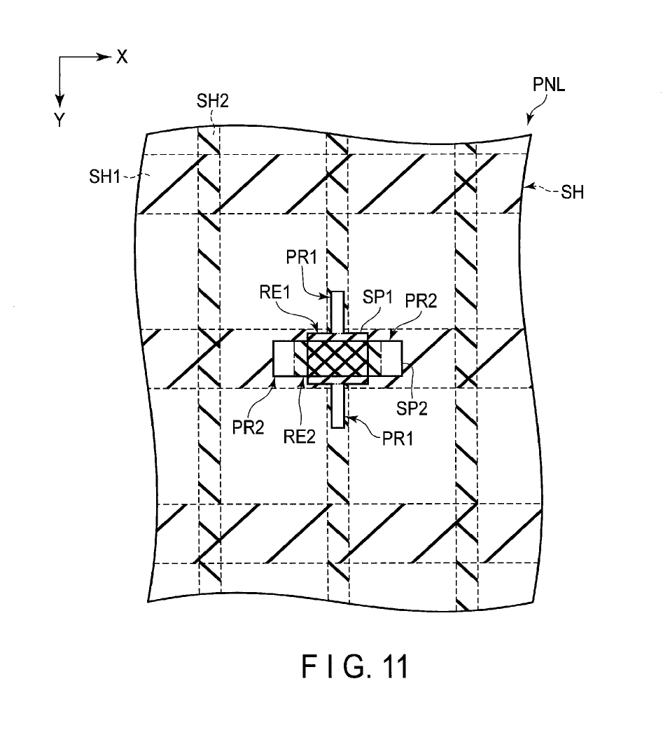

FIG. 11 is a view showing a first modification of the arrangement of the light-shielding layer and the spacers.

The present modification is different from the structural example of FIG. 3 in that the first projecting portion PR1 is disposed along the second extension portion SH2. The first receiving portion RE1 is disposed in an area opposed to the first extension portion SH1, which is wider than the second extension portion SH2. The width of the first projecting portion PR1 in the first direction X is less than the width of the first receiving portion RE1 in the first direction X. According to this structure, the present modification can increase the size of the first receiving portion RE1. That is, in the display device DSP, it is possible to increase the load to be imposed on each pair of the first spacer SP1 and the second spacer SP2 and to decrease the number of the first spacers SP1 and the second spacers SP2.

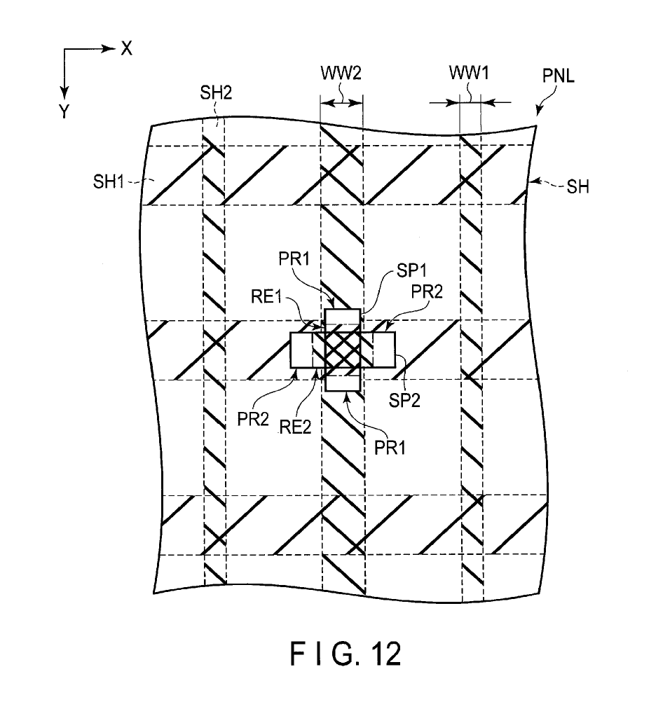

FIG. 12 is a view showing a second modification of the arrangement of the light-shielding layer and the spacers.

In the present modification, a width WW2 in the first direction X of a second extension portion SH2 which is opposed to the first spacer SP1 and the second spacer SP2 is greater than a width WW1 in the first direction X of a second extension portion SH2 which is unopposed to the first spacer SP1 and the second spacer SP2. In this way, it is possible to increase the size of the first spacer SP1 opposed to the second extension portion SH and thereby increase the size of the first receiving portion RE1.

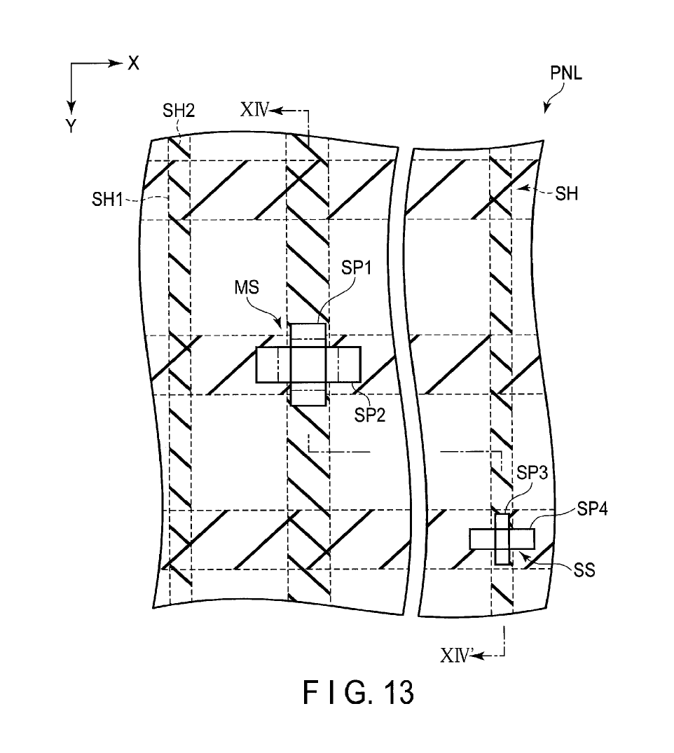

FIG. 13 is a view showing the arrangement of a light-shielding layer and spacers of a display panel comprising a sub-spacer.

The present modification is different from the structural example of FIG. 12 in that the display panel PNL comprises a main spacer MS composed of the first spacer SP1 and the second spacer SP2 as well as a sub-spacer SS composed of a third spacer SP3 and a fourth spacer SP4. Note that the main spacer MS is not necessarily limited to this structure and may be formed in accordance with any structural examples of the embodiments. The main spacer MS supports the cell gap GP in a state where the display panel PNL is not subjected to an external force. In the sub-spacer SS, the third spacer SP3 and the fourth spacer SP4 are separated from each other in the third direction Z in a state where the display panel PNL is not subjected to an external force. Note that, in a state where the display panel PNL is subjected to an external force, the third spacer SP3 and the fourth spacer SP4 of the sub-spacer SS contact each other and support the cell gap GP.

The third spacer SP3 and the fourth spacer SP4 cross each other in a position where the first extension portion SH1 and the second extension portion SH2 cross each other. For example, the third spacer SP3 is arranged along the second extension portion SH2 and is opposed to the second extension portion SH2 in the third direction Z. Further, the fourth spacer SP4 is arranged along the first extension portion SH1 and is opposed to the first extension portion SH1 in the third direction Z. In the example shown in the drawing, the third spacer SP3 and the fourth spacer SP4 are opposed to both the first extension portion SH1 and the second extension portion SH2 in the third direction Z. Since the width of the third spacer SP3 in the first direction X is less than the width of the first spacer SP1 in the first direction X, the width in the first direction X of a second extension portion SH2 which is opposed to the sub-spacer SS may be less than the width in the first direction X of a second extension portion SH2 which is opposed to the main spacer MS.

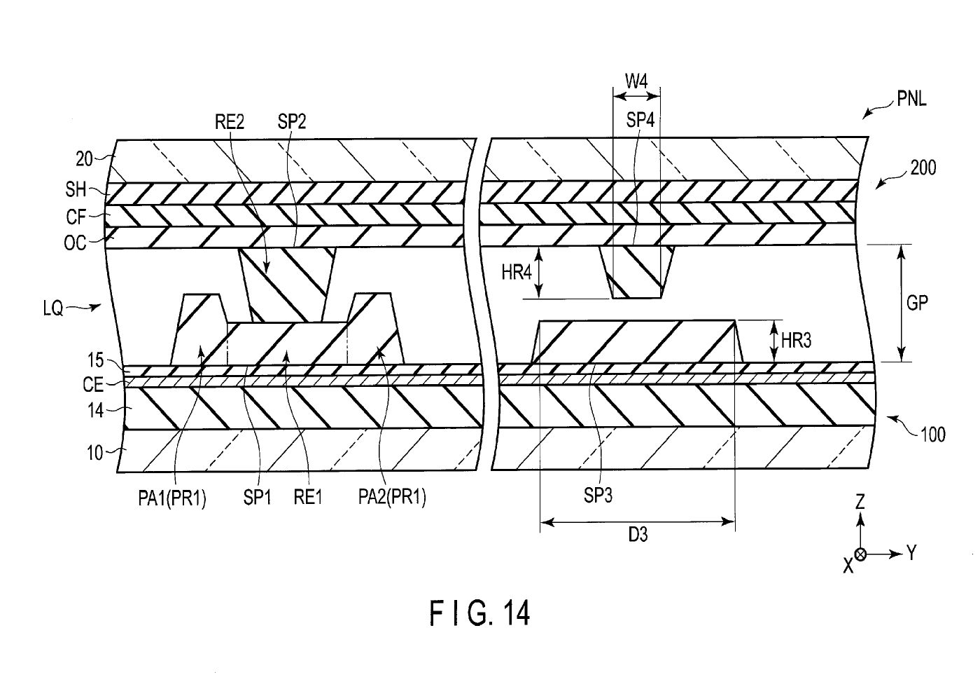

FIG. 14 is a sectional view showing the display panel along line XIV-XIV′ of FIG. 13.

In the example shown in the drawing, as in the case of the first spacer SP1, the third spacer SP3 is disposed on the first substrate 100 and projects toward the second substrate 200. Further, as in the case of the second spacer SP2, the fourth spacer SP4 is disposed on the second substrate 200 and projects toward the first substrate 100.

In a state where the display panel PNL is not subjected to an external force, the third spacer SP3 and the fourth spacer SP4 are separated from each other in the third direction Z. In a state where the display panel PNL is subjected to an external force, the third spacer SP3 and the fourth spacer SP4 are in proximity to or in contact with each other in the third direction Z. In the example shown in the drawing, the third spacer SP3 has a height HR3 in the third direction Z and has a length D3 in the second direction Y. The fourth spacer SP4 has a height HR4 in the third direction Z and has a width W4 in the second direction Y. The length D3 is greater than the width W4. According to the structure comprising the sub-spacer SS, when an external force is applied to the display panel PNL, concentration of the impact on the main spacer MS can be reduced.

Note that the third spacer SP3 may comprise a projecting portion such as that of the first spacer SP1. Similarly, the fourth spacer SP4 may comprise a projecting portion such as that of the second spacer SP2.

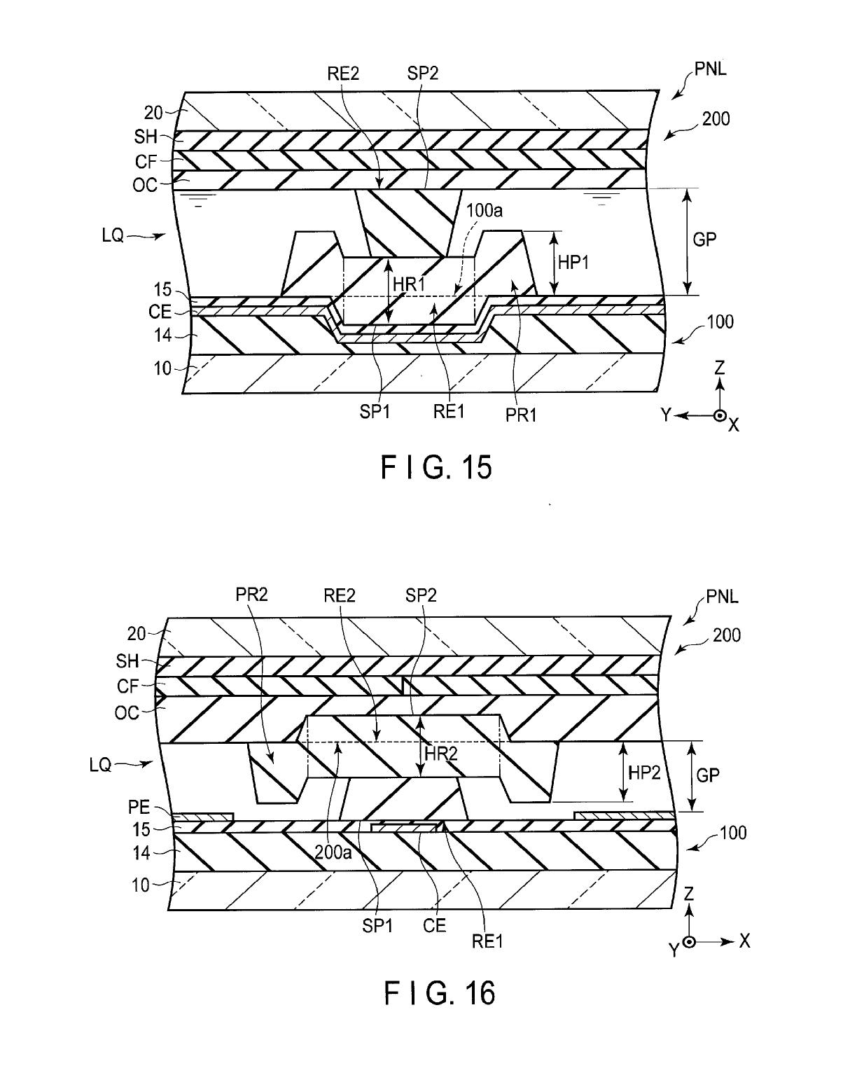

FIG. 15 is a view showing a modification of the first substrate and the first spacer of FIG. 4.

The present modification is different from the structural example of FIG. 4 in that the first substrate 100 comprises a recessed portion 100a below the first receiving portion RE1.

In the recessed portion 100a, a surface of the first substrate 100 which is opposed to the second substrate 200 is recessed. That is, the bottom surface of the first receiving portion RE1 is separated from the second substrate 200 with respect to the bottom surface of the first projecting portion PR1. Therefore, even if the height HR1 of the first receiving portion RE1 is the same as the height HP1 of the first projecting portion PR1, the first projecting portion PR1 projects toward the second substrate 200 with respect to the first receiving portion RE1. That is, in the present modification, it is possible to form the first spacer SP1 comprising the first receiving portion RE1 without using the gradated mask in the manufacturing process of the first spacer SP1.

To form the recessed portion 100a, for example, the thickness of the fourth insulating film 14 in a position opposed to the first receiving portion RE1 is reduced. Note that the recessed portion 100a is not necessarily formed by a particular method and may be formed, for example, by a method of reducing the thickness of the fifth insulating film 15 in a position opposed to the first receiving portion RE1 or by a method of forming an opening penetrating through the first insulating film 15 or the common electrode CE in the third direction Z in a position opposed to the first receiving portion RE1. In other words, the first receiving portion RE1 may be formed on the fourth insulating film 14, and the first projecting portion PR1 may be formed on the fifth insulating film 15 or the common electrode CE.

FIG. 16 is a view showing a modification of the second substrate and the second spacer of FIG. 5.

The present modification is different from the structural example of FIG. 5 in that the second substrate 200 comprises a recessed portion 200a above the second receiving portion RE2.

In the recessed portion 200a, a surface of the second substrate 200 which is opposed to the first substrate 100 is recessed. Therefore, in the present modification, even if the height HR2 of the second receiving portion RE2 is the same as the height HP2 of the second projecting portion PR2, the second projecting portion PR2 projects toward the first substrate 100 with respect to the second receiving portion RE2. That is, it is possible to form the second spacer SP2 comprising the second receiving portion RE2 without using the gradated mask in the manufacturing process of the second spacer SP2. To form the recessed portion 200a, for example, the thickness of the overcoat layer OC in a position opposed to the second receiving portion RE2 is reduced. Note that the recessed portion 200a may also be formed by a method of reducing the thicknesses of the color filter CF or the light-shielding layer SH in a position opposed to the second receiving portion RE2 or by a method of forming an opening penetrating through the overcoat layer OC, the color filter CF or the light-shielding layer SH in the third direction Z in a position opposed to the second receiving portion RE2.

As described above, according to the present embodiment, a display device which can prevent substrate misalignment can be achieved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate;
a second substrate opposed to the first substrate;
a first spacer disposed on the first substrate and projecting toward the second substrate; and
a second spacer disposed on the second substrate, projecting toward the first substrate, and crossing the first spacer, wherein
the first spacer comprises a first receiving portion and a first projecting portion projecting toward the second substrate with respect to the first receiving portion, and
the second spacer comprises a second receiving portion contacting the first receiving portion.

2. The display device of claim 1, wherein the first projecting portion comprises a first portion and a second portion disposed respectively at both ends of the first receiving portion.

3. The display device of claim 1, wherein
a cell gap between the first substrate and the second substrate is greater than a height of the first projecting portion, and
the first projecting portion is separated from the second substrate.

4. The display device of claim 1, wherein a cell gap between the first substrate and the second substrate is less than a sum of a height of the first projecting portion and a height of the second receiving portion.

5. The display device of claim 2, wherein a length of the first receiving portion between the first portion and the second portion is greater than or equal to a width of the second receiving portion.

6. The display device of claim 1, wherein the second spacer comprises a second projecting portion projecting toward the first substrate with respect to the second receiving portion.

7. The display device of claim 6, wherein the second projecting portion comprises a third portion and a fourth portion disposed respectively at both ends of the second receiving portion.

8. The display device of claim 6, wherein
a cell gap between the first substrate and the second substrate is greater than a height of the second projecting portion, and
the second projecting portion is separated from the first substrate.

9. The display device of claim 6, wherein a cell gap between the first substrate and the second substrate is less than a sum of a height of the second projecting portion and a height of the first receiving portion.

10. The display device of claim 7, wherein a length of the second receiving portion between the third portion and the fourth portion is greater than or equal to a width of the first receiving portion.

11. The display device of claim 1, wherein a cell gap between the first substrate and the second substrate is less than or equal to a sum of a height of the second receiving portion and a height of the first receiving portion.

12. The display device of claim 1, further comprising a light-shielding layer comprising a first extension portion and a second extension portion crossing the first extension portion, wherein
the first spacer and the second spacer are disposed where the first extension portion and the second extension portion cross each other.

13. The display device of claim 12, further comprising:
a scan line opposed to the first extension portion; and
a signal line opposed to the second extension portion, wherein
the first spacer is arranged along the first extension portion, and
the second spacer is arranged along the second extension portion.

14. The display device of claim 13, wherein the second spacer is disposed on a substrate where the light-shielding layer is disposed.

15. The display device of claim 12, further comprising:
a first drain electrode and a second drain electrode which are opposed to the first extension portion;
a first pixel electrode electrically connected to the first drain electrode via a first contact hole; and
a second pixel electrode electrically connected to the second drain electrode via a second contact hole, wherein
the first spacer is located between the first contact hole and the second contact hole.

16. The display device of claim 1, further comprising an alignment film covering the first spacer.

17. The display device of claim 1, wherein
the first receiving portion and the first projecting portion are arranged in a first direction, and
a width of the first projecting portion in a second direction crossing the first direction is less than a width of the first receiving portion in the second direction.

18. The display device of claim 12, wherein
the light-shielding layer further comprises a third extension portion extending in a first direction and arranged along the first extension portion in a second direction crossing the first direction, and
a width of the first extension portion in the second direction is greater than a width of the third extension portion in the second direction.

19. The display device of claim 1, further comprising:
a third spacer disposed on the first substrate and projecting toward the second substrate; and
a fourth spacer disposed on the second substrate, projecting toward the first substrate, crossing the third spacer, and separated from the third spacer.

20. The display device of claim 1, wherein a bottom surface of the first receiving portion is separated from the second substrate with respect to a bottom surface of the first projecting portion.
